(19) United States
(12) Patent Application Publication
(10) Pub. No.: US 2020/0234359 A1
(43) Pub. Date: Jul. 23, 2020

(54) Dynamically Personalized Product Recommendation Engine Using Stochastic and Adversarial Bandits

(71) Applicant: Mad Street Den, Inc., Redwood City, CA (US)

(72) Inventors: Annavajhala Satyadev Sarma, Chennai (IN); Janani Sriram, Bangalore (IN); Anand Chandrasekaran, Chennai (IN); Niranjan Mujumdar, Chennai (IN)

(21) Appl. No.: 16/745,799

(22) Filed: Jan. 17, 2020

Related U.S. Application Data
(60) Provisional application No. 62/794,260, filed on Jan. 18, 2019.

(51) Int. Cl. G06Q 30/06; G06N 20/00

(52) U.S. Cl. CPC G06Q 30/0631; G06N 20/00

(57) ABSTRACT

A method for recommending products to a user includes providing a user profile with product related data. At least one bandit is generated to model product related recommendations. The bandit model(s) are passed to a recommendation module that provides recommendations to the user based on the bandit model and expected payoff. User interactions in response to the recommendation can be evaluated to adjust further recommendations.

### CROSS-REFERENCE TO RELATED APPLICATIONS

This application claims priority to U.S. Provisional Patent Application Ser. No. 62/794,260, filed Jan. 18, 2019, titled “Dynamically Personalized Product Recommendation Engine Using Stochastic and Adversarial Bandits” which is incorporated herein by reference in its entirety, including but not limited to those portions that specifically appear hereinafter, the incorporation by reference being made with the following exception: In the event that any portion of the above-referenced application is inconsistent with this application, this application supersedes the above-referenced application.

### FIELD OF THE INVENTION

This invention relates generally to a system capable of providing consumer relevant product recommendations or choices for e-commerce sites. Strategies for creating recommendations using stochastic and adversarial bandit methods are described.

### BACKGROUND

Typically, when a user visits an e-commerce site, a strategy for ranking and sorting the product catalog is picked and the top recommendations are shown. This can be based on the user's history of engagement with different products from clickstream data and can be designed to be exploitative of the user's past explicit interests. Other strategies for determining recommendations can include collaborative filtering techniques that create personalized recommendations by leveraging user similarities based on behavioral attributes. Alternatively, content-based filtering can build a user profile using items in their history and data derived from overlap with other users. Another strategy uses market basket analysis to identify ‘frequently bought together’ items.

Unfortunately, these purely data-driven approaches are subject to noisiness due to ‘mixed intent’—where users buy groups of items that do not logically pair well together. For instance, people may purchase quality clothing for an adult fashion ensemble along with outdoor work clothes in a single purchase basket, leaving the decision to buy matching fashionable items at a later time. Such decisions can make identifying logically connected items using just clickstream data problematic and error-prone. As another example, recommendations can be provided based on the user's history of engagement with different products. Unfortunately, such recommended products tend to be similar to what the user has already bought. Particularly in fashion conscious markets such as clothing retail or interior decorating, this might be ineffective. If a user has already purchased a particular scarf or couch, in many cases, they are unlikely to buy something similar and the recommendation will be ignored.

All the foregoing approaches are typically employed in e-commerce sites with large amounts of traffic. These approaches can suffer from cold-start problems (new user/new product) and data sparsity problems. Typically, these techniques operate in batch mode and are not intended for volatile, real-time situations that require online learning to support functions such as dynamic personalization. These approaches also do not track evolution of user interests or session-level drifts in known user preferences. Finally, many recommendation approaches progress greedily towards a set of top recommendations but miss out on recommendations offering a better balance that include not only prior history but novel/surprise recommendations.

### SUMMARY

In one described embodiment, a method for recommending products to a user includes providing a user profile with product related data. At least one bandit is generated to model product related recommendations. The bandit model(s) are passed to a recommendation module that provides recommendations to the user based on the bandit model and expected payoff. User interactions in response to the recommendation can be evaluated to adjust further recommendations.

In another described embodiment, a method for dynamically recommending products to a user includes receiving a request for a personal recommendation. A bandit payoff is weighted, and bandit recommendations assembled. Recommendations are provided to the user and further user interactions in response to the provided recommendation can be evaluated to adjust weighting of the bandit payoff.

### BRIEF DESCRIPTION OF THE DRAWINGS

The specific features, aspects and advantages of the present invention will become better understood with regard to the following description and accompanying drawings where:

FIG. 1 illustrates a cloud-based system for recommendations derived at least in part from adversarial methods;

FIG. 2 illustrates a recommendation system that uses a bandit factory to support adversarial methods; and

FIG. 3 illustrates a bandit-based recommendation system.

### DETAILED DESCRIPTION

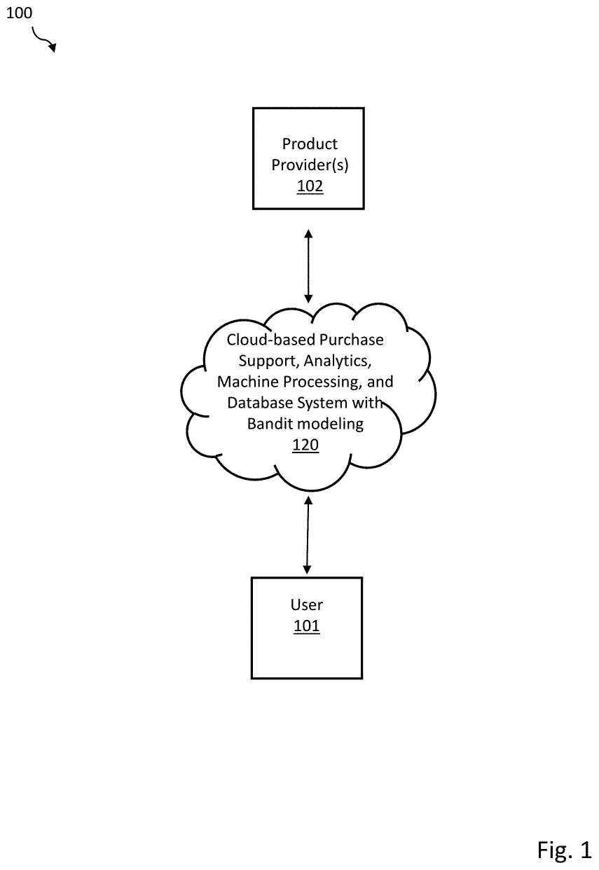

FIG. 1 illustrates recommendation system 100 that can provide a consumer or user 101 with high quality recommendations for related products and/or services. A product provider 102, which can include retailers, wholesalers, e-commerce sites, or the like, can provide or permit access to product and sales data 110. This information can be used by a cloud-based system 120 that in some embodiments can provide purchase support, analytics, machine learning systems and processing, a database system, along with an ability to create a recommendation of one or more related products or services to a user. This recommendation is based at least in part by a personalization system that can include stochastic or adversarial modeling to explore various dimensions of user 101 interest. Recommendations can be related to similar products or retail ensembles (i.e. a set of product types that can be logically paired with each other). For example, an ensemble of fashion outfits and accessories is comprised of individual items specifically designed, or fortuitously styled, in a manner that allows them to be worn together. A fashion ensemble could include formal shirts with trousers and pumps. Other examples can be furniture ensembles that include furniture items that can be positioned together harmoniously in a room, kitchenware ensembles of dipping bowls, placemats and napkins.

In effect, the recommendation system 100 personalizes product recommendations by using various strategies that together understand and balance user sensitivities to various dimensions of exploration and exploit knowledge of strongly expressed user affinities. These strategies can be supplemented with serendipitous personalization, to present relevant products without pigeon-holing (into a limited number of product categories). The system 100 can model mixing probabilities of user intents rather than assuming clean one-dimensional intents, dynamically react to user click-through feedback, and develop an execution order of different strategies influenced by the sequence of user interactions.

In one embodiment, the recommendation system 100 provides a hybrid approach for mixing discrimination of user intent through pre-configured stationary strategies along with learning of intents by introducing bandits (details of “bandit” origin and usage to be later discussed) having an adversarial strategy by competitively changing behavior based on performance of other bandits. A set of hybrid bandits can be used to generate different kinds of recommendation, including those that based on product similarity, and those that are based on customized landing pages. Similar products typically provide alternatives to a current source product based on product similarity functions such as visual similarity. Customized landing pages provide a selection of products relevant to the user 101 based on the full user history and known preferences. For example, a user 101 may want to see all shoes that are on-sale, without respect to past purchases, along with complementary products related to recent purchases (e.g, a top that matches a recently purchased skirt).

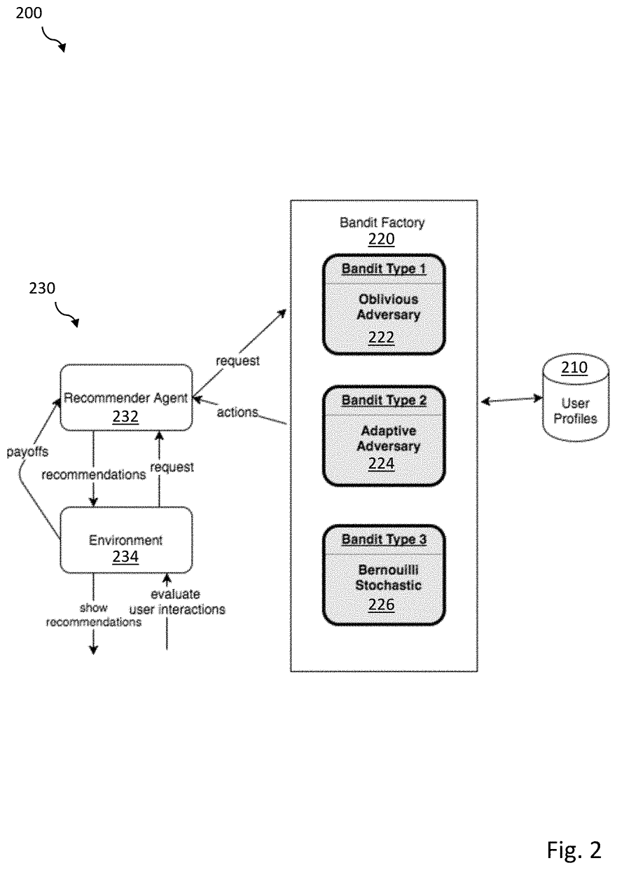

As discussed with respect to FIG. 2, system 200 can be a component of system 100 of FIG. 1 that relies on reinforcement learning to actively explore its environment to gather information and exploit learned knowledge to make decision or prediction related to product recommendations. In one embodiment, especially suitable for learning in uncertain environments, the system 200 can be modelled as a sequential decision problem, in which the agent's utility depends on a sequence of decisions. In such systems agents have a model of the world and through a series of actions and observations obtain information about the world which can then be exploited for planning and computing an optimal policy that determines the next sequence of actions. Typically, the mathematical framework for modeling sequential decision problems (with full transition probabilities that can be solved through reinforcement learning) includes a set of states and actions, a transition model of probabilities, and a reward function given the state and action. In an e-commerce retail context, recommendations that are presented to the user can be modeled as actions in the environment, with subsequent user interactions modeled as payoffs.

More specifically, as seen with respect to system 200 of FIG. 2, procedures for generating recommendations can use, but are not limited to, a module supporting user product related profiles 210 that provide and receive data from a bandit factory 220. User related profile data can include, but is not limited to provided user historical data, product data and metadata, visual and non-visual data related to products, and associations mined from traffic patterns.

Various types of bandits can be generated by the bandit factory 220, including an oblivious adversary bandit 222, an adaptive adversary 224, or a stochastic bandit 226. Results of one or more bandits are provided to a recommendation module 230 that includes a recommender agent 232 that can model interactions with environment 234. The recommender agent 232 receives requests and payoff data, while providing recommendations to environment 234

In one embodiment, the bandit factory 220 provides an e-commerce friendly implementation of a multi-armed bandit (MAB) problem, a well-known sequential decision problem. A MAB can be understood with reference to an agent faced with a slot machine (colloquially known as a “one-armed bandit”). For a MAB including k-arms, drawing arm i will result in a random reward payoff r. The reward payoffs are sampled from an unknown distribution p(i) specific to each arm. The agent's objective is to learn enough to maximize the total payoff (reward) given a number of draws. Alternatively, the goal can be seen as minimizing total regret over T trials. The set of arms is known to the agent. Each arm has an unknown probability distribution p(i). The agent has a known number of T trials. At the t-th round, the agent can pull an arm t(i) and observe a random payoff r(i,t). The objective is to wisely choose the arms at each trial to balance exploration and exploitation.

Suppose there are k-arms and T trials:

$$Trails \text{:} t = \{ 1 , 2 , … T \}$$

$$Choice \text{:} {t}_{i} ∈ \{ 1 , 2 , … K \}$$

$$Reward \text{:} {r}_{{i}_{t}} ∈ ℛ for chosen arm i at trial t$$

Goal: To maximize total reward

$${\sum }_{t = 1}^{T} {r}_{{i}_{t}}$$

A naive greedy strategy exists: the agent first randomly pulls all arms to gather information to learn the probability distribution of each arm (exploration) and then always pulls the arm that yields the maximum predicted payoff (exploitation). However, in the case of too much exploration the learned information is not greatly used. Alternatively, in the case of too much exploitation the agent does not have sufficient information to make accurate predictions resulting in suboptimal total reward. For best results, the selected strategy should balance the two. A number of approaches exist to make theoretically optimal decisions at each step. Two such formulations, each based on different assumptions about the environment as explained in subsequent sections, include stochastic MABs and adversarial MABs.

For stochastic MABs the rewards are stochastic. Each arm i ∈ [K] is associated with a fixed unknown probability distribution p(i) on [0, 1], and rewards from arm i are assumed to be drawn independent and identically distributed from p(i). Alternatively, for adversarial MABs there are no probabilistic assumptions on the rewards r(i,t). Instead, the rewards can be generated by an adversary who is generating a fixed sequence of rewards.

The recommendation agent determines the strategies for selecting an arm to pull according to the information available to it at each trial. When an arm is drawn it indicates the corresponding item is shown as a recommendation on the e-commerce product page. When the recommended item matches the user preference (e.g., corresponding product is clicked in the carousel), a corresponding reward is obtained. The reward may be binary (1 for the arms that recommended product that was clicked and 0 for all other arms) or continuous (arms get a reward proportional to the ‘closeness’ of the product clicked). The updated information is fed back to optimize the strategies. The optimal strategy is to draw the arm with the maximum expected reward with respect to information available at each trial, and then to maximize the total accumulated reward for the whole series of trials.

In effect, stochastic or adversarial bandits can be used to select among different recommendation strategies for blending together visual, traffic-based, or non-visual strategies that provide a personalized exploration sensitivity profile for the user. Bandit based systems can be very flexible and able to accommodate various recommendation system outcomes. For example, even if two arms generate visually similar recommendations with different tuning parameters that end up with the same product in their top-N list, a non-binary payoff scheme that rewards both arms commensurately can be used to improve recommendations. Alternatively, adversarial bandits can be used, and parameters learned and directly from the observed payoff to form adaptive adversarial arms that modify their own behavior based on observed user actions.

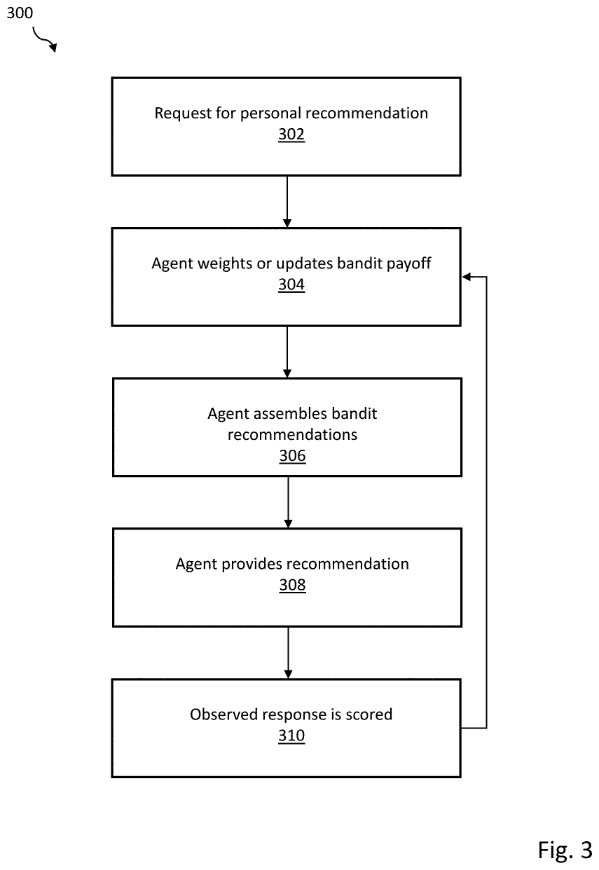

One aspect on this modeling strategy can be illustrated with respect to flow chart 300 of FIG. 3 as follows:

Step 302—An incoming request arrives, and the state of the world is observed by a bandit system. The incoming request could be anchored on a specific product (show products similar to current product) or a non-anchored exploration scenario (customized landing page/personalized category listing page/inspired by your browsing history).

Step 304—The agent receives the incoming state from the system and draws from the bandits weighted by their expected payoffs. These weights can be iteratively updated.

Step 306—The agent assembles the recommendations in response to the incoming request. The recommendations are sorted by their expected utility of each product given the context.

Step 308—The agent returns the action, in this case—the recommendations to be presented to the user, to the system.

Step 310—The system then observes the response (rewards/regrets) arising from this action using predefined scoring functions against user interactions such as click, buy etc. It then sends updated weights to the agent for iterative processing as step 304, repeating as necessary.

Various types of bandits can be used. For example, a federation bandit can be used to assemble the buffet of recommendations. Arm distributions can be set as fixed and independent of each other. Rewards can be binary and based on implicit (e.g., click=1/no click=0 or buy=1/no buy=0) and explicit (like=1, dislike=0) user feedback and mutually exclusive (i.e, there is only one winning bandit). In some embodiments, a Bayesian approach can be used to model the probability of success of each bandit. The learned parameters are used in importance sampling to get blending proportions to get top-N federated recommendations.

Alternatively, tuning bandits can be used for fine-tuning and understanding the performance of small changes to strategies, including but not limited to parameter search by price, brand etc. Since the strategies are not orthogonal to each other, bandit trials do not assume a single winner. Rewards can be continuous in the range 0 to 1. Rewards do not have to be generated by fixed but unknown distributions as in the stochastic case but can be set by an exponential weight update approach.

Various other reward functions are also possible, including those based on reciprocal rank or similarity score. Reciprocal rank reward can be a function of the rank of the product that received positive user feedback. One of the bandits is chosen as the winner (the most recent winner, the one with the highest rank etc.) and gets a reward of 1. The remaining bandits are rewarded based on the rank of the product in their world view. Alternatively, a similarity score-based reward function can have one of the bandits chosen as winner and the remaining bandits rewarded as a function of the distance between their top product(s) from the winning product.

Modeling strategies can include but are not limited to adversarial strategies. Adversarial strategies can be stationary or adaptive. A stationary adversarial strategy uses a value function that generates the top recommendations from each bandit but does not change over time. For example, if a suite of bandits are introduced that show trending products that are close in color affinity to a given user, the value function that scores the products does not change over time. Different sets of parameters may quantized and assigned to different bandits. Over time some of the bandits in the suite may win more draws than others but their parameters do not change.

Alternatively, and adversarial bandit model strategy can be used. A set of bandits is set to peek into the winning item and adjust its value function to generate a different set of recommendations. Over time adaptive bandits move closer to the winning bandits by stealing parameters. For example, if a user seems to be clicking more on apparel items with floral patterns across several trials, the adaptive bandit changes its value function to boost floral patterns.

The described bandit systems have other advantages over conventional systems, including an ability to support warm starts (as compared to a cold start with limited data from a new user). Typically, the starting bandit configuration assumes that all arms are equally likely. In the Bayesian case for warm starts, the prior information can be initially set by feeding in pseudo counts in rewards using simulations from past purchases and population behavior. Similarly, in the adversarial case the starting weights can be initially adjusted for the various arms based on available user data or population/cohort data derived from similar users.

Another advantage of the described systems is the ability to support parameter decay functions. These ensure temporal relevance of the bandits and the conditions under which to take online learning back to long-term preferences and/or retire stale data. Various kinds of temporal decay functions can be used to dampen the impact of old learning from the system or ignore minor deviations in well-understood preferences.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Devices can have touch screens as well as other I/O components.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. A method for recommending products to a user, the method comprising the steps of:
providing a user profile with product related data;
generating at least one bandit to model product related recommendations;
passing the bandit model to a recommendation module that provides recommendations to the user based on the bandit model and expected payoff; and
evaluating user interactions in response to the recommendation to adjust further recommendations.

2. The method of claim 1, wherein the user profile data is derived at least partially from at least one of product related user data and traffic-based link data.

3. The method of claim 1, wherein the bandit is an adversarial bandit.

4. The method of claim 1, wherein the bandit is an adaptive adversarial bandit.

5. The method of claim 1, wherein the bandit is an stationary adversarial bandit.

6. The method of claim 1, wherein the bandit is a federation bandit.

7. The method of claim 1, wherein the bandit is a tuning bandit.

8. The method of claim 1, wherein the bandit uses a reward functions based on reciprocal rank.

9. The method of claim 1, wherein the bandit uses a reward functions based on similarity score.

10. The method of claim 1, wherein the recommendation module provides dynamic personalization.

11. A method for dynamically recommending products to a user, the method comprising the steps of:
receiving a request for a personal recommendation;
weighting a bandit payoff;
assembling bandit recommendations;
providing recommendations to the user; and
evaluating further user interactions in response to the provided recommendation to adjust weighting of the bandit payoff.
